(19) United States
(12) Patent Application Publication
(10) Pub. No.: US 2009/0123732 A1
(43) Pub. Date: May 14, 2009

(54) Electroconductive Metal Film and Production Method Thereof

(75) Inventors: Masaya Yukinobu, Chiba (JP); Yuki Murayama, Chiba (JP); Kenji Kato, Chiba (JP)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: SUMITOMO METAL MINING CO., LTD., Tokyo (JP)

(21) Appl. No.: 11/918,275

(22) PCT Filed: Apr. 11, 2006
(86) PCT No.: PCT/JP2006/307653

§ 371 Date: Oct. 11, 2007

(30) Foreign Application Priority Data
Apr. 12, 2005 (JP) 2005-115155

(51) Int. Cl. B32B 15/08; B05D 5/12

(52) U.S. Cl. 428/328; 427/123

(57) ABSTRACT

A method of producing an electroconductive metal film and an electroconductive metal film produced thereby, the production method being capable of forming an electroconductive metal film having a low resistance by utilizing a compression treatment even when a conventional electroconductive metal film forming coating liquid (fine metal particle colloidal dispersion) is adopted and subjected to a drying treatment or heat treatment at a low temperature. The method includes adopting an electroconductive metal film forming coating liquid containing therein fine metal particles as a main component; coating the coating liquid onto a substrate; subsequently drying the coated coating liquid; and applying a compression treatment to the dried residual to form an electroconductive metal film on the substrate.

### TECHNICAL FIELD

The present invention relates to an electroconductive film production method for forming an electroconductive metal film onto a substrate such as made of plastic and to an electroconductive metal film obtained by such the production method, and particularly relates to a method capable of inexpensively and expediently producing an electroconductive metal film having a lower resistance value even by a heat treatment (drying or the like) at a relatively low temperature.

### BACKGROUND ART

Although there has been used an electroconductive paste comprising a solvent containing a resin binder, and fine silver particles or fine copper particles dispersed therein and having an averaged particle diameter of several μm or more, such a paste leads to an excessively higher surface resistivity, so that it has been proposed exemplarily by JP-A-2002-334618, WO 2002/035554 and JP-A-2002-75999 to adopt fine silver particles or fine copper particles having an averaged particle diameter of 100 nm or less and to conduct printing of a fine metal particle colloidal dispersion (paste) at a high concentration such as by screen printing, followed by final firing at a temperature of about 200° C. to obtain an electroconductive metal film.

However, since the fine metal particle colloidal dispersions to be used in JP-A-2002-334618, WO 2002/035554 and JP-A-2002-75999 were each produced by a gas evaporation method configured to evaporate/condense silver, copper, or the like in a gas under reduced pressure and to collect it into a solvent containing a polymeric dispersant, its productivity was extremely low such that the obtained fine metal particle colloidal dispersion (paste) was also extremely expensive. Particularly, since the fine metal particle colloidal dispersion (paste) was configured to contain therein a polymeric dispersant (which may be a compound) for strongly bonding onto surfaces of fine silver particles, fine copper particles, or the like so as to enhance dispersion stability, it was required to apply a high-temperature heat treatment at about 200° C. after coating (printing)/drying so as to improve electroconductivity of a metal film by decomposing such a polymeric dispersant.

To solve such a problem and exemplarily concerning fine silver particles, there has been widely known a Carey-Lea method configured to more easily prepare a fine silver particle colloidal dispersion without containing therein a polymeric dispersant such as adopted in M. Carey Lea, Am. J. Sci, 37, 491, (1889). Further, as a method for producing an electroconductive metal film by fine silver particles by adopting such a Carey-Lea method, there has been proposed a method for producing an electroconductive silver film forming coating liquid (fine silver particle colloidal dispersion) without containing a polymeric dispersant, such as described in WO 2004/096470. According to this method, there can be obtained an electroconductive silver film having a relatively low resistance by a heat treatment at about 100° C. or lower.

However, it is difficult to attain a satisfactorily low value for the resistance of the electroconductive silver film formed by the heat treatment (including heating upon drying) under a relatively low temperature such as 100° C. or lower even by the above-described electroconductive metal film production method which adopts such an electroconductive silver film forming coating liquid (fine silver particle colloidal dispersion) without containing a polymeric dispersant, and it has been impossible to form an excellent electroconductive silver film having a low resistance by a heat treatment at a much lower temperature (such as 60° C.), thereby problematically failing to achieve particular application to a plastic substrate such as made of an acrylic resin having a lower heat resistance. Further, in case of obtaining an electroconductive copper film by using a fine copper particle colloidal dispersion (paste), there is required a heat treatment at about 200° C. upon film formation, thereby exhibiting a problem that application is not allowed except to a specific heat-resistant plastic substrate such as polyimide.

### DISCLOSURE OF THE INVENTION

### Problem to be Solved by the Invention

The present invention has been carried out in view of the above problem, and it is therefore an object of the present invention to provide an electroconductive metal film production method and an electroconductive metal film, the production method being capable of providing an electroconductive metal film having a low resistance by applying a compression treatment while applying a drying treatment or heat treatment only at a low temperature, in case of adopting a conventional electroconductive metal film forming coating liquid (fine metal particle colloidal dispersion).

### Means for Solving the Problem

To achieve the above object, the present invention provides an electroconductive metal film production method recited in claim 1 comprising the steps of:

adopting an electroconductive metal film forming coating liquid containing therein fine metal particles as a main component;

coating the coating liquid onto a substrate;

subsequently drying the coated coating liquid; and

applying a compression treatment to the dried residual to form an electroconductive metal film on the substrate.

The invention recited in claim 2 resides in the electroconductive metal film production method of claim 1, wherein the fine metal particles are one or more kinds selected from noble metal-containing fine particles, copper-containing fine particles, and nickel-containing fine particles having an averaged particle diameter of 500 nm or less.

The invention recited in claim 3 resides in the electroconductive metal film production method of claim 2, wherein the noble metal-containing fine particles contain silver and/or gold as a main component.

The invention recited in claim 4 resides in the electroconductive metal film production method of any one of claims 1 through 3, wherein the substrate is a plastic substrate in a plate-like or film-like shape.

The invention recited in claim 5 resides in the electroconductive metal film production method of any one of claims 1 through 4, wherein the drying step is conducted at a low temperature in a range of 20 to 100° C.

The invention recited in claim 6 resides in the electroconductive metal film production method of any one of claims 1 through 5, wherein the compression treatment is a rolling treatment by metal rolls.

The invention recited in claim 7 resides in the electroconductive metal film production method of any one of claims 1 through 6, further comprising the step of:

additionally conducting a heat treatment during and/or after the compression treatment.

The invention recited in claim 8 resides in an electroconductive metal film obtained by the production method of any one of claims 1 through 7.

### EFFECT OF THE INVENTION

According to the electroconductive metal film production method of the present invention, it is possible to form an electroconductive metal film having a low resistance by conducting a compression treatment even in case of adopting an existing electroconductive metal film forming coating liquid (fine metal particle colloidal dispersion) and conducting a drying treatment or heat treatment at a low temperature (drying at about 100 to 60° C. or lower in case of adopting fine silver particles as fine metal particles, for example), thereby enabling application even to a plastic substrate having an extremely low heat resistance, to thereby provide industrial usefulness. Further, it is possible to obtain the same effect as the above by applying a rolling treatment, even in case of adopting an electroconductive metal film forming coating liquid (fine metal particle colloidal dispersion) containing a small amount of a polymeric dispersant, a binder component such as resin, or the like, and conducting a drying treatment at a low temperature, to thereby provide industrial usefulness.

### BEST MODE FOR CARRYING OUT THE INVENTION

Examples of the present invention will be described in detail.

According to the present invention, it is possible to densify fine metal particles by conducting a compression treatment for a film comprising fine metal particles obtained in a manner that, an electroconductive metal film forming coating liquid such as an electroconductive silver film forming coating liquid (fine silver particle colloidal dispersion) including a solvent containing a small amount or substantially no amount of a polymeric dispersant, a binder component such as resin, or the like, and containing, as a main component, fine metal particles dispersed in the solvent, is coated onto a substrate, followed by a drying treatment at a low temperature; thereby enabling restriction of occurrence of voids within the thus formed electroconductive fine metal particle film. From a standpoint of densification of fine metal particles upon compression treatment, the drying treatment is to be preferably conducted in a low temperature region where fusion bonding of fine metal particles occurs hardly; and the temperature is 100° C. or lower, and more preferably 60° C. or lower in case of exemplarily adopting fine silver particles in a nano-size though depending on a treatment time. This is because, when the temperature of a drying treatment is high and fusion bonding among fine metal particles is progressed, densification of fine metal particles will be obstructed upon the subsequent compression treatment. Further, conducting such a compression treatment enables occurrence of fusion bonding among fine metal (nano)particles, thereby remarkably increasing electroconductivity. This also has an effect of smoothing a surface of an electroconductive metal film, and it is even possible to achieve an averaged surface roughness (Ra) of about several nm, depending on adopted fine metal particles. It is also possible to further promote fusion bonding among fine metal particles to thereby achieve a much lower resistance, by additionally conducting a heat treatment during or after the compression treatment. Although the temperature of the heat treatment during or after the compression treatment is not particularly limited and can be appropriately selected depending on the kind of fine metal particles, the kind of the used substrate, an applicable device, and the like, the temperature is 60° C. or higher, preferably 100° C. or higher from a standpoint of promoted fusion bonding among fine particles. Only, it is required to adopt a temperature set to be higher than the above heat treatment temperature, in case of fine metal particles such as copper or nickel where fusion bonding is more difficult to be caused than fine particles such as silver or gold where fusion bonding is easily caused. Note that the heating and drying treatment before the compression treatment is called a “drying treatment” and the heat treatment after the compression treatment is called a “heat treatment” in the present specification, for clarification of meanings of terms.

Although the compression treatment to be adopted in the present invention can be conducted by various methods, the treatment is desirably a rolling treatment by two metal rolls. Although the linear pressure of the rolls upon compression treatment may be appropriately selected, it is preferable to adopt a linear pressure of 50 to 500 kgf/cm (49 to 490N/mm) for a roll diameter of about 100 mm. Although higher linear pressures enable achievement of more densification of fine metal particles, excessively higher linear pressures may lead to distortion or breakage of a substrate and lead to a large-sized rolling apparatus which is disadvantageous in cost.

Fine metal particles to be used in the present invention are configured to have an averaged particle diameter of 500 nm or less, preferably 100 nm or less, and more preferably 50 nm or less, thereby enabling promotion of low temperature fusion bonding among fine metal particles, to remarkably lower a resistance value of an electroconductive metal film. Desirable as fine metal particles are fine silver particles, or fine particles containing silver as main components, in view of a lower specific resistance value thereof and readiness of fusion bonding thereamong. Only, since fine silver particles may cause a problem of electromigration, it is possible to appropriately select and use: other fine noble metal particles such as fine gold particles; fine alloy particles of silver and another noble metal, such as fine silver-gold particles; complex fine particles; copper-containing fine particles; nickel-containing fine particles; and the like, depending on an applicable device, usage environment, and the like.

The electroconductive metal film forming coating liquid (fine metal particle colloidal dispersion) to be used in the present invention is preferably configured to contain a small amount or substantially no amount of a dispersant such as a polymeric dispersant, a binder component such as resin, or the like. This is because, containing a large amount of a polymeric dispersant, a binder component such as resin, or the like, tends to obstruct densification and fusion bonding of fine silver particles during a compression treatment process.

Examples of a substrate usable in the present invention include plate-like or film-like plastic substrates such as polyethylene terephthalate (PET), polyethylene naphthalate (PEN), polybutylene terephthalate (PBT), polyvinyl butyral (PVB), acrylates (PMMA, PMA), polycarbonates (PC), polyethersulfone (PES), polyphenylene sulfide (PPS), cyclo-olefin resins, fluororesins, polyimide (PI), polyacetal (POM), polyalylate (PAR), polyamide, polyamide imide (PAI), polyetherimide (PEI), polyether ether ketone (PEEK), liquid crystal polymer (LCP), and the like, and without limited to these materials, also include those substrates insofar as simply capable of being compression treated. In addition to the plastic substrates, it is also possible to adopt glass, ceramic substrates, organic-inorganic hybrid substrates (such as fiberglass reinforced plastic), and the like.

The electroconductive silver film forming coating liquid (fine silver particle colloidal dispersion) as an example of the electroconductive metal film forming coating liquid (fine metal particle colloidal dispersion) to be used in the present invention can be prepared by the following method. Namely, it is possible by the Carey-Lea method to exemplarily mix an aqueous silver nitrate solution into a mixed solution of an aqueous iron(II) sulfate solution with an aqueous sodium citrate solution to thereby cause a reaction, and to filter and wash the obtained aggregations of fine silver particles to obtain a cake thereof, followed by addition of pure water to the cake, thereby obtaining a fine silver particle colloidal dispersion (fine silver particle concentration: about 0.1 to 10 parts by weight).

Utilizing the ordinary Carey-Lea method typically obtains fine silver particles having particle diameters of about 5 to 15 nm. However, utilizing a method of heating and maturing the reaction solution containing the fine silver particle aggregations obtained by the Carey-Lea method, enables obtainment of a fine silver particle colloidal dispersion having larger particle diameters (30 nm to 60 nm, for example). While the Carey-Lea method provides the aqueous fine silver particle colloidal dispersion where fine silver particles are dispersed in water, there is obtained an electroconductive silver film forming coating liquid by concentrating and washing the colloidal dispersion and by adding an appropriate organic solvent thereto.

In addition to Ag, it is possible to adopt, as fine metal particles to be used in the present invention, fine particles containing metal selected from Au, Pt, Ir, Pd, Rh, Ru, Os, Re, Cu, Ni, and the like (such as fine particles of the noted metal; fine alloy particles of the noted metals; or noble-metal-coated fine silver particles comprising fine silver particles coated with the noted noble metal other than silver). Further, comparing specific resistances of silver, gold, platinum, rhodium, ruthenium, palladium, and the like with one another, the specific resistances of platinum, rhodium, ruthenium, and palladium are 10.6, 4.51, 7.6, and 10.8 μΩ·cm, respectively, which are higher than specific resistances 1.62 and 2.2 μΩ·cm of silver and gold, respectively, so that it is assumed to be advantageous to adopt fine silver particles or fine gold particles in order to form an electroconductive film having a lower surface resistivity.

Only, adopting fine silver particles leads to limitation of usages from a standpoint of weather resistance such as due to sulfuration and salt water, while adopting fine gold particles, fine platinum particles, rhodium, fine ruthenium particles, fine palladium particles, and the like overcomes the problem of weather resistance but is not necessarily optimum in view of cost.

As such, it is also possible to adopt fine particles comprising fine silver particles having surfaces coated with noble metal other than silver (i.e., noble-metal-coated fine silver particles) as mentioned above. Note that usable for such noble-metal-coated fine silver particles are the transparent electroconductive film forming coating liquids and production methods thereof described in JP-A-11-228872 and JP-A-2000-268639 matured from those patent applications previously filed by the present applicant, respectively.

Next, the coating amount of simple gold or platinum, or composite of gold and platinum in the noble-metal-coated fine silver particles, is preferably set to be in a range between 5 parts by weight inclusive and 1900 parts by weight, more preferably between 100 parts by weight inclusive and 900 parts by weight, relative to 100 parts by weight of silver. This is because, coating amounts of simple gold or platinum, or composite of gold and platinum less than 5 parts by weight tend to cause film degradation due to affection of ultraviolet rays and the like to fail to exhibit an effect of coating protection, while coating amounts exceeding 1900 parts by weight rather deteriorate productivity of noble-metal-coated fine silver particles and exhibit a problem of cost. Note that there is a situation where adoption of an electroconductive silver film is not allowed, because, in addition to the problem of weather resistance such as a degradation due to sulfuration, there is caused a problem of electromigration (a phenomenon in an environment of presence of water where application of an electric field between silver electrodes results in extension of dendrite silver from one of the silver electrode to the other to form a short circuit) depending on an applicable device, usage environment, and the like. In such a situation, it is possible to appropriately select and adopt other fine noble metal particles, other fine alloy particles or complex fine particles of fine silver particles with other noble metal, copper-containing fine particles, nickel-containing fine particles, or the like.

The colloidal dispersion containing fine metal particles therein can also be produced by a method for obtaining fine metal particles and then dispersing the fine metal particles into an organic solvent. For production of fine metal particles here, it is possible to adopt a general method for preparing an aqueous solution (A) (hereinafter called “(A) solution”) containing therein salts of one kind or two or more kinds of metals intended for deposition as metal colloid, followed by reduction by a reducing agent. As the metal salt, it is desirable to use a water-soluble metal salt which can be easily reduced by a reducing agent. Although kinds of metal salts are different depending on metal species, it is typically desirable to adopt nitrates, nitrites, sulfates, chlorides, acetates, and the like.

Examples of usable and desirable kinds of metal salts include: Au: gold(I) chloride, gold(II) chloride, chloroauric acid, alkali aurate; Pt: platinum(II) chloride, platinum(II) ammonium chloride, alkali platinate; Ir: iridium trichloride, iridium tetrachloride, ammonium iridium hexachloride, tripotassium iridium hexachloride, iridium acetate; Pd: palladium chloride, ammonium palladium tetrachloride, potassium palladium hexachloride, palladium acetate, palladium nitrate; Ag: silver nitrate, silver nitrite; Rh: rhodium trichloride, ammonium rhodium hexachloride, potassium rhodium hexachloride, hexamine rhodium chloride, rhodium acetate; Ru: ruthenium nitrosonitrate, ruthenium chloride, ammonium ruthenium chloride, potassium ruthenium chloride, ruthenium sodium chloride, ruthenium acetate; Os: osmium trichloride, ammonium osmium hexachloride; Re: rhenium trichloride, rhenium pentachloride; Cu: copper sulfate, copper nitrate; and Ni: nickel formate, nickel acetate, nickel chloride, nickel nitrate, nickel sulfate; without limited thereto.

The obtained fine metal particles can be mixed with an organic solvent (with addition of a small amount of dispersant, a binder component such as resin, or the like, as required), and the mixed solution can be brought into a fine metal particle colloidal dispersion by using a general method such as ultrasonic dispersion, and bead mill dispersion. Note that the organic solvent to be used for the electroconductive silver film forming coating liquid and the fine metal particle colloidal dispersion to be obtained by the Carey-Lea method, can be appropriately selected in view of a compatibility with the electroconductive silver film forming coating liquid and the fine metal particle colloidal dispersion, a solubility relative to a substrate, and a film-forming condition. Examples of the organic solvent include: alcohol based solvents such as methanol (MA), ethanol (EA), 1-propanol (NPA), isopropanol (IPA), butanol, pentanol, benzyl alcohol, diacetone alcohol (DAA); ketone based solvents such as acetone, methyl ethyl ketone (MEK), methyl propyl ketone, methyl isobutyl ketone (MIBK), cyclohexanone, isophorone; ester based solvents such as ethyl acetate, butyl acetate, methyl lactate; glycol derivatives such as ethylene glycol monomethyl ether (MCS), ethylene glycol monoethyl ether (ECS), ethylene glycol isopropyl ether (IPC), ethylene glycol monobutyl ether (BCS), ethylene glycol monoethyl ether acetate, ethylene glycol monobutyl ether acetate, propylene glycol methyl ether (PGM), propylene glycol ethyl ether (PE), propylene glycol methyl ether acetate (PGM-AC), propylene glycol ethyl ether acetate (PE-AC), diethylene glycol monomethyl ether, diethylene glycol monoethyl ether, diethylene glycol monobutyl ether, diethylene glycol monomethyl ether acetate, diethylene glycol monoethyl ether acetate, diethylene glycol monobutyl ether acetate, diethylene glycol dimethyl ether, diethylene glycol diethyl ether, diethylene glycol dibutyl ether, dipropylene glycol monomethyl ether, dipropylene glycol monoethyl ether, dipropylene glycol monobutyl ether; benzene derivatives such as toluene, xylene, mesitylene, dodecyl benzene; and formamide (FA), N-methyl formamide, dimethyl formamide (DMF), dimethyl acetamide, dimethylsulfoxide, N-methyl-2-pyrrolidone (NMP), γ-butyrolactone, ethylene glycol, diethylene glycol, tetrahydrofuran (THF), chloroform, mineral spirits, and terpineol, without limited thereto. In case of addition of a polymeric dispersant, a binder component such as resin, or the like as required, the amount thereof is desirably at least 20 wt % or less, preferably 10 wt % or less, and more preferably 5 wt % or less, relative to fine metal particles of the metal colloidal dispersion. This is because, amounts exceeding 20 wt % of the polymeric dispersant, the binder component such as resin, or the like relative to fine metal particles of the metal colloidal dispersion, obstruct densification of fine metal particles and fusion bonding thereamong during the compression treatment process, thereby deteriorating a resistance value of an obtained electroconductive metal film.

The electroconductive metal film forming coating liquid can be subjected to film-formation by coating the liquid onto a whole surface of a substrate or in a patterned manner by screen printing, gravure printing, ink jet printing, wirebar coating, doctor blade coating, roll coating, spin coating, or the like. As described above, the coating liquid is coated onto a substrate and dried at a low temperature to obtain a film comprising fine metal particles which is then subjected to a compression treatment, thereby enabling densification of the fine metal particles to restrict occurrence of voids within the formed electroconductive fine metal particle film. Further, achievement of such a compression treatment causes fusion bonding among fine metal (nano)particles, thereby enabling a remarkably increased electroconductivity. This also provides an effect for smoothing the surface of the electroconductive metal film. In case of the above-described patterned coating, the compression treatment is conducted to densify the coated and dried film at the patterned portion, thereby enabling obtainment of a patterned electroconductive metal film excellent in electroconductivity.

As explained above, it becomes possible to form an electroconductive metal film having a low resistance even onto a plastic substrate having a considerably lower heat resistance, by the electroconductive metal film production method of the present invention.

### EXAMPLES

Although the Examples of the present invention will be concretely explained, the present invention is not limited to these Examples. Note that “%” represents “wt %” and “parts” represent “parts by weight” in the description.

### Example 1

176 g of an aqueous 9.1% silver nitrate (AgNO₃) solution was mixed into and subjected to reaction with a mixed solution of 208 g of an aqueous 23.1% iron sulfate (FeSO₄) solution and 256 g of an aqueous 37.5% sodium citrate (C₃H₄(OH)(COONa)₃.2H₂O) solution, to obtain a reaction solution containing fine silver particle aggregations therein. Note that the temperatures of the mixed solution of the aqueous iron sulfate solution and the aqueous sodium citrate solution and of the aqueous silver nitrate solution were set at 20° C. and 10° C., respectively.

The obtained reaction solution in a state contained in a vessel was left to stand in an incubator at 65° C. for 16 hours. Fine silver particle aggregations in the reaction solution after the maturing process were filtered out by a centrifuge to obtain a cake of fine silver particle aggregations, followed by addition of pure water to the cake to conduct washingout, thereby obtaining a fine silver particle colloidal dispersion (Ag: 0.96%).

Fine silver particles in the obtained fine silver particle colloidal dispersion had an averaged particle diameter of 50 nm, and exhibited a uniform distribution of particle sizes where fine silver particles in particulate shapes and having particle diameters of 35 to 65 nm made up 90% or more of the whole of fine silver particles.

The fine silver particle colloidal dispersion was concentrated and washed by ultrafiltration, thereby obtaining a concentrated/washed fine silver particle colloidal dispersion (Ag: 50%, balance water). The solvent (water) in this concentrated/washed fine silver particle colloidal dispersion had an electric conductivity of 160 μS/cm which was a value obtained by measuring the filtrate derived from the ultrafiltration.

Added to the concentrated/washed fine silver particle colloidal dispersion were dimethylsulfoxide (DMSO), 1-butanol (NBA), diacetone alcohol (DAA), and ethanol (EA), thereby obtaining a silver film forming coating liquid (Ag: 20%, DMSO: 2.5%, H₂O: 20%, EA: 42.5%, NBA: 5%, and DAA: 10%). Fine silver particles in the obtained silver film forming coating liquid had an averaged particle diameter of 50 nm, and exhibited a uniform distribution of particle sizes where fine silver particles in granular shapes and having particle diameters of 35 to 65 nm made up 90% or more of the whole of fine silver particles. The viscosity was 3 mPa·s.

Next, the silver film forming coating liquid was coated onto a PET film (Tetoron HLEW made by Teijin Limited, thickness: 100 μm, treated with primer) by a wirebar having a wire diameter of 1.0 mm, and dried at 50° C. for 5 minutes in the atmospheric air, followed by a rolling treatment (linear pressure: 100 kgf/cm=98N/mm, nip width=0.7 mm, feeding rate of substrate=1 m/min) by two metal rolls (roll diameter: 100 mm) plated by hard chrome, thereby obtaining an electroconductive silver film according to Example 1. The electroconductive silver film exhibited such an external appearance that the portion without rolling treatment was a metallic glossy film in copper color and having a lower reflectivity, and the portion subjected to the rolling treatment was a metallic glossy electroconductive film in silver color having a higher reflectivity. The electroconductive silver film had a film thickness of 1.3 μm, and a surface resistivity of 2.2Ω/□ (ohm per square) (286 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

The viscosity of the concentrated fine silver particle colloidal dispersion was measured by a vibration-type viscometer VM-100-L made by Yamaichi Electronics Co., Ltd. The surface resistivity of the electroconductive silver film was measured by a surface resistance meter LORESTAR AP (MCP-T400) made by Mitsubishi Chemical Corporation. The film thickness of the electroconductive silver film was measured by observing a cross section of the film by a transmission electron microscope.

### Example 2

There was obtained an electroconductive silver film according to Example 2 in the same manner as Example 1, except that the rolling treatment condition of Example 1 was changed (linear pressure: 200 kgf/cm=196N/mm, nip width=0.6 mm). The electroconductive silver film had a film thickness of 1.2 μm, and a surface resistivity of 0.60Ω/□ (72 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Example 3

There was obtained an electroconductive silver film according to Example 3 in the same manner as Example 2, except for addition of a heat treatment in the atmospheric air at 70° C. for 1 hour after the rolling treatment in Example 2. The electroconductive silver film had a film thickness of 1.2 μm, and a surface resistivity of 0.21Ω/□ (25.2 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Example 4

There was obtained an electroconductive silver film according to Example 4 in the same manner as Example 2, except for addition of a heat treatment in the atmospheric air at 120° C. for 1 hour after the rolling treatment in Example 2. The electroconductive silver film had a film thickness of 1.2 μm, and a surface resistivity of 0.08Ω/□ (9.6 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Example 5

There was obtained an electroconductive silver film according to Example 5 in the same manner as Example 2, except for achievement of the rolling treatment in Example 2 after heating the metal rolls to 100° C. (rolling treatment while heating). The electroconductive silver film had a film thickness of 1.2 μm, and a surface resistivity of 0.27Ω/□ (32.4 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400). Note that the heating time of the substrate through the heated metal rolls was calculated to be 0.04 second or shorter, based on the nip width=0.6 mm and the substrate feeding rate=1 m/min.

### Example 6

1 g of 1-butanol (NBA) and 1 g of diacetone alcohol (DAA) were added to 18 g of a fine silver/gold particle dispersion (CKRF-HTN: Au—Ag=1.4%, Ag/Au=1/4 [weight ratio], made by SUMITOMO METAL MINING CO., LTD.) containing gold-coated fine silver particles having particle diameters of 5 to 10 nm and dispersed in the solvent in a state that the fine particles were connected in a concatenate state, followed by sufficient mixing to obtain a silver/gold film forming coating liquid.

Next, the silver/gold film forming coating liquid was spin coated (at 110 rpm for 5 seconds [liquid dispense], and at 200 rpm for 100 seconds [drying]) onto a PET film (Tetoron HLEW made by Teijin Limited, thickness: 100 μm, treated with primer) heated to 40° C., followed by a rolling treatment (linear pressure: 200 kgf/cm=196 N/mm, nip width=0.6 mm, feeding rate of substrate=1 m/min) at a room temperature by two metal rolls (roll diameter: 100 mm) plated by hard chrome, thereby obtaining an electroconductive silver/gold film according to Example 6. The electroconductive silver/gold film had a film thickness of 120 nm, and a surface resistivity of 40Ω/□ (480 μΩ·cm when calculated as specific resistance). Further, the electroconductive silver/gold film had a visible light transmittance of 46.1% and a haze value of 0.2%. Note that absence of cracks was confirmed as a result of observation of the electroconductive silver/gold film by a scanning electron microscope. Further, even when the electroconductive silver/gold film was rubbed with a finger, peeling of the electroconductive silver/gold film from the substrate film was not observed, thereby allowing confirmation of strong adherence.

Note that the visible light transmittance and the haze value were those of the electroconductive silver/gold film itself excluding the PET film as the substrate, and can be obtained from the following [Equation 1] and [Equation 2], respectively. Namely,

Transmittance (%) of electroconductive silver/gold film itself excluding substrate=[(transmittance measured together with substrate)/(transmittance of substrate)]×100 [Equation 1]

Haze value (%) of electroconductive silver/gold film itself excluding substrate=(haze value measured together with substrate)−(haze value of substrate) [Equation 2]

Here, used in the present specification as a transmittance is a value of a visible light transmittance of an electroconductive silver/gold film itself excluding a substrate, unless otherwise stated.

Further, the haze value and visible light transmittance of the electroconductive silver/gold film were measured by a hazemeter (HR-200) made by MURAKAMI COLOR RESEARCH LABORATORY Co., Ltd.

### Example 7

30 g of fine copper particles (UCP-030 made by SUMITOMO METAL MINING CO., LTD.) having an averaged particle diameter of 300 nm was mixed with 20 g of cyclohexanone containing a small amount of polymeric dispersant, followed by ultrasonic dispersion, to obtain a copper film forming coating liquid (Cu: 60%, cyclohexanone: 40%).

Next, the copper film forming coating liquid was coated onto a PET film (Tetoron HLEW made by Teijin Limited, thickness: 100 μm, treated with primer) by a wirebar having a wire diameter of 0.15 mm, and dried at 50° C. for 5 minutes in the atmospheric air, followed by a rolling treatment (linear pressure: 300 kgf/cm=294N/mm, nip width=1.0 mm) at a room temperature by two metal rolls (roll diameter: 220 mm) plated by hard chrome, thereby obtaining an electroconductive copper film according to Example 7. The electroconductive copper film had a film thickness of 1.2 μm, and a surface resistivity of 10Ω/□ (1200 μΩ·cm when calculated as specific resistance). Note that absence of cracks was confirmed as a result of observation of the electroconductive copper film by a scanning electron microscope. Further, even when the electroconductive copper film was rubbed with a finger, peeling of the electroconductive copper film from the substrate film was not observed, thereby allowing confirmation of strong adherence.

### Example 8

There was obtained an electroconductive copper film according to Example 8 in the same manner as Example 7, except that rolling treatment in Example 7 was conducted by heating the metal rolls to 100° C. The electroconductive copper film had a film thickness of 1.2 μm, and a surface resistivity of 5Ω/□ (600 μΩ·cm when calculated as specific resistance). Note that absence of cracks was confirmed as a result of observation of the electroconductive copper film by a scanning electron microscope. Further, even when the electroconductive copper film was rubbed with a finger, peeling of the electroconductive copper film from the substrate film was not observed, thereby allowing confirmation of strong adherence.

### Comparative Example 1

There was obtained an electroconductive silver film according to Comparative Example 1 in the same manner as Example 1, except that the rolling treatment in Example 1 was not conducted. The electroconductive silver film had a film thickness of 1.5 μm, and a surface resistivity of 10000Ω/□ (1.5Ω·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Comparative Example 2

There was obtained an electroconductive silver film according to Comparative Example 2 in the same manner as Comparative Example 1, except for addition of a heat treatment in the atmospheric air at 70° C. for 1 hour after drying at 50° C. for 5 minutes in the atmospheric air in Comparative Example 1. The electroconductive silver film had a film thickness of 1.5 μm, and a surface resistivity of 5.2Ω/□ (780 μΩ·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Comparative Example 3

There was obtained an electroconductive silver film according to Comparative Example 3 in the same manner as Comparative Example 1, except for addition of a heat treatment in the atmospheric air at 100° C. for 1 second after drying at 50° C. for 5 minutes in the atmospheric air in Comparative Example 1. The electroconductive silver film had a film thickness of 1.5 μm, and a surface resistivity of 9000Ω/□ (1.35Ω·cm when calculated as specific resistance). Note that absence of cracks was confirmed as a result of observation of the electroconductive silver film by a scanning electron microscope. The electroconductive silver film exhibited an excellent adhesion force of 100/100 to a substrate film, when evaluated by a cross-cut adhesive tape peeling test method (JIS K5400).

### Comparative Example 4

There was obtained an electroconductive silver/gold film according to Comparative Example 4 in the same manner as Example 6, except that the rolling treatment in Example 6 was not conducted. The electroconductive silver/gold film had a film thickness of 130 nm, and a surface resistivity of 80 Ω/□ (1040 μΩ·cm when calculated as specific resistance). Further, the electroconductive silver/gold film had a visible light transmittance of 51.0% and a haze value of 0.2%. Note that absence of cracks was confirmed as a result of observation of the electroconductive silver/gold film by a scanning electron microscope. Further, when the electroconductive silver/gold film was rubbed with a finger, slight peeling of the electroconductive silver/gold film from the substrate film was observed.

### Comparative Example 5

There was obtained an electroconductive copper film according to Comparative Example 5 in the same manner as Example 7, except that the rolling treatment in Example 7 was not conducted. The electroconductive copper film had a surface resistivity of 10MΩ/□ or more (although not measured, the film thickness was assumed to be about 1.5 μm, so that the resistance was assumed to be 1500Ω·cm or more when calculated as specific resistance). Note that absence of cracks was confirmed as a result of observation of the electroconductive copper film by a scanning electron microscope. When the electroconductive copper film was lightly rubbed with a finger, the electroconductive copper film was easily peeled from the substrate film, thereby clarifying a considerably lower adhesion force.

“Evaluation”

Comparing the electroconductive silver films of Examples 1 and 2 with the electroconductive silver film of Comparative Example 1 which films were all formed by the heating and drying processes at a temperature as low as 50° C., it is seen that the surface resistivity of the electroconductive silver films of Examples are as low as 0.6 to 2.2Ω/□ by virtue of the rolling treatment, whereas the surface resistivity of the electroconductive silver film of Comparative Example 1 is considerably as high as 10000Ω/□. Further, comparing the electroconductive silver film of Example 3 with the electroconductive silver film of Comparative Example 2 which films were both subjected to the heat treatment at 70° C. after drying of the coated film at 50° C., it is seen that the surface resistivity of the electroconductive silver film of Example 3 is as low as 0.21Ω/□ by virtue of the rolling treatment, whereas the surface resistivity of the electroconductive silver film of Comparative Example 2 is as high as 5.2Ω/□.

Further, comparing the electroconductive silver film of Example 5 with the electroconductive silver film of Comparative Example 3 which films were both subjected to the heat treatment at 100° C. for about 1 second, it is seen that the surface resistivity of the electroconductive silver film of Example 5 is as low as 0.27Ω/□by virtue of the rolling treatment, whereas the surface resistivity of the electroconductive silver film of Comparative Example 3 is as high as 9000Ω/□.

Comparing the electroconductive silver/gold film of Example 6 with the electroconductive silver/gold film of Comparative Example 4 which films were both subjected to film-formation by coating and drying by spin coating, it is seen that the surface resistivity of the electroconductive silver/gold film of Example 6 is as low as 40Ω/□ by virtue of the rolling treatment, whereas the surface resistivity of the electroconductive silver/gold film of Comparative Example 4 is 80Ω/□ which is about two times larger.

Moreover, comparing the electroconductive copper films of Examples 7 and 8 with the electroconductive copper film of Comparative Example 5 which films were all subjected to film formation in the heating and drying processes at a temperature as low as 50° C., it is seen that the surface resistivity of the electroconductive copper films of Examples are as low as 5 to 10Ω/□ by virtue of the rolling treatment, whereas the surface resistivity of the electroconductive copper film of Comparative Example 5 is considerably as high as 10 MΩ/□ or more. It is further seen that the electroconductive copper films of Examples 7 and 8 are each strongly adhered to the substrate film whereas the electroconductive copper film of Comparative Example 5 has a considerably lower adhesion force to the substrate film.

### INDUSTRIAL APPLICABILITY

According to the electroconductive metal film production method of the present invention, it is possible to form an electroconductive metal film having a low resistance by utilizing a compression treatment even when an existing electroconductive metal film forming coating liquid (fine metal particle colloidal dispersion) is adopted and subjected to a drying treatment at a low temperature (such as drying at about 100 to 60° C. or lower in case of adoption of fine silver particles as fine metal particles), so that the production method can also be applied to even a plastic substrate having a considerably lower heat resistance, thereby providing an extremely remarkable industrial applicability.

1. A method of producing an electroconductive metal film comprising the steps of:
adopting an electroconductive metal film forming coating liquid containing therein fine metal particles as a main component; coating the coating liquid onto a substrate;
subsequently drying the coated coating liquid; and
applying a compression treatment to the dried residual to form an electroconductive metal film on the substrate.

2. The method of claim 1, wherein the fine metal particles are at least one kind selected from noble metal-containing fine particles, copper-containing fine particles, and nickel-containing fine particles having an averaged particle diameter of 500 nm or less.

3. The method of claim 2, wherein the noble metal-containing fine particles contain silver and/or gold as a main component.

4. The method of claim 1, wherein the substrate is a plastic substrate in a plate-like or film-like shape.

5. The method of claim 1, wherein the drying step is conducted at a low temperature in a range of 20 to 100° C.

6. The method of claim 1, wherein the compression treatment is a rolling treatment by metal rolls.

7. The method of claim 1, further comprising the step of:
additionally conducting a heat treatment during and/or after the compression treatment.

8. An electroconductive metal film obtained by the production method of claim 1.
